(19) United States
(12) Patent Application Publication
(10) Pub. No.: US 2007/0034271 A1
(43) Pub. Date: Feb. 15, 2007

(54) Residual pressure valve

(76) Inventors: Frank Zenses, Hurth (DE); Harald Hagen, Wipperfurth (DE); Reiner Grundel, Gummersbach (DE)

Correspondence Address: BRINKS HOFER GILSON & LIONE, P.O. BOX 10395, CHICAGO, IL, 60610, US

(21) Appl. No.: 11/374,286

(22) Filed: Aug. 15, 2005

(30) Foreign Application Priority Data
Aug. 16, 2004 (DE) DE202004012793.8

(51) Int. Cl. F16K 15/14

(52) U.S. Cl. 137/853

(57) ABSTRACT

The present invention relates to a residual pressure valve having a valve body and a valve seat. The valve seat is formed by a flexible tubular piece which is fixed in a housing, consists of an elastomer and surrounds the valve body under elastic prestress. Furthermore, the valve body is formed by an axially symmetrical control element. The control element has a cylindrical, barrel-like or biconical basic shape and has a hollow space in each case starting from each of its axial ends, which is in each case connected via at least one channel to an annular control chamber. The control chamber is arranged in the outer surface of the control element and is separated from the respective other control chamber by a radial intermediate wall resting on the flexible tubular piece.

### FIELD OF THE INVENTION

The present invention relates to a residual pressure valve having a valve body and a valve seat, the valve seat being formed by a flexible tubular piece which is fixed in a housing, consists of an elastomer and surrounds the valve body under elastic prestress, and the valve body being formed by an axially symmetrical control element.

### BACKGROUND OF THE INVENTION

Residual pressure valves, which are known in various types of design, are normally used if a pressure container or a line under pressure is not to be emptied completely. It is therefore possible to prevent, for example, another medium, such as ambient air, penetrating into a container containing a specific fluid or into the corresponding line. During the use of residual pressure valves, safety requirements, aspects of the cleanest possible refilling or corrosion-preventative considerations can play a part. It is characteristic of residual pressure valves that they open as a function of reaching a specific response pressure or, respectively, close, in particular when the pressure falls below a minimum limiting pressure. For instance, such a pressure for the case of rupture of a line in an air suspension system is about 5 bar.

A valve of the general type discussed above is described by EP-A-0 800 032. That patent describes a valve for central lubricating systems, which is arranged as a shut-off valve between a pump output from a pump unit and an operating unit and comprises an input line, an output line, an inner flexible elastomer tube, an axially asymmetrical shut-off element, in particular a ball, and clamping connections. In this case, the clamping connections can be covered with a shrinkable tube, so that a type of housing is produced. As a result of the arrangement provided of the input line and the output line in their relationship with the inner flexible elastomer tube, the shut-off element is an inner flexible elastomer tube between the input line and the output line, in each case the clamping connector squeezing the inner flexible elastomer tube in such a way that the input line and the output line are sealed off via the flexible elastomer tube. The pressure difference between the pressure of the lubricant pump and a contact stress of the inner flexible elastomer tube on the shut-off element affects the opening and closing of the shut-off valve, in that the inner flexible elastomer tube forms a sleeve between the clamping connectors and allows a quantity of lubricant assigned to the pressure difference to pass through. In this way, the shut-off element forms a tribological arrangement with the inner flexible elastomer tube and the lubricant. In this case, the valve additionally has an outer flexible elastomer tube and a passage notch arranged at one end of the end face of the output line and is formed in such a way that, as a result of the pressure of the lubricant pump, the sum of the contact stress of the outer flexible elastomer tube and the inner flexible elastomer tube on the shut-off element is overcome and an annular gap is formed, it firstly being possible for the lubricant to be delivered directly via the passage notch into the output line leading to the frictional point but, secondly, at a pressure of the lubricant pump which is lower than that necessary for opening the annular gap, the shut-off valve remains closed. The inner flexible elastomer tube is in this case chosen with regard to the type of lubricant, while the outer flexible elastomer tube should have fatigue-free, predefined characteristic elasticity values. The free mobility of the ball when forming the annular chamber under the action of the pressure of the lubricant pump in this case represents an uncertainty factor with regard to the precise fulfillment of the function of the valve.

The present invention is based on the object of providing a residual pressure valve of the type discussed previously, in particular with a suitability for air suspension systems, which is distinguished by low cost construction and mounting and by an ability to respond to pressure which is precise and presettable.

### SUMMARY OF THE INVENTION

According to the invention, the object is achieved in that the control element has a cylindrical, barrel-like or biconical basic shape, a hollow space being formed in each case starting from each of its axial ends, which is in each case connected via at least one channel, in particular a channel oriented radially, to an annular control chamber, which is arranged in the outer surface of the control element and is separated from the respective other control chamber by a radial intermediate wall resting on the flexible tubular piece. As a result of the annular shape of the control chamber, these elements can easily be fabricated, specifically by means of a turning operation. In addition, the annular shape permits a uniform circumferential application of pressure.

If a medium under filling pressure flows through the residual pressure valve according to the invention from a filling side, then it passes through the hollow space arranged on the filling side, in particular an axial bore through the radially oriented channel, into the first control chamber, which is larger, as compared with the other. In this case, larger is to be understood to mean that the area of the flexible tube enclosing the control chamber, that is the effective pressure area with respect to the flexible tubular piece, is greater than the enclosing area of the flexible tube or effective pressure area of the second control chamber on the residual pressure side. The enclosing area of the flexible tube is in this case acted on with a filling pressure which acts against the flexible tubular piece. The latter thus advantageously not only performs the function of the valve seat but also the function of a spring. In this case, firstly, the cost of construction is kept low and, secondly, the valve body does not need to carry out any movements in order to open or close the valve. Below a predeterminable response pressure, the area of the flexible tube enclosing the control chamber on the filling side blocks the flow of the fluid.

Additionally, in a preferred embodiment of this invention, provision can advantageously be made for a predetermined prestress to be set with the aid of a spring surrounding the flexible tubular piece circumferentially, in particular a spring band or a clamp-like spring, by which means higher precision and stability can be achieved. The pressure therefore acts not only against the flexible tubular piece but also against a spring. By means of the diameter of the flexible tubular piece and the diameter of the control element in the region of the intermediate wall, which can be matched to each other while taking account of the modulus of elasticity of the flexible tube material, and also the characteristic of the spring, the prestress and therefore the response pressure of the valve can advantageously be varied. The arrangement of a spring on the circumference of the flexible tubular piece can also be advantageous, irrespective of the specific formation of the control chambers or the other components, so that this feature is independently a subject of the invention in conjunction with the previously described residual pressure valve.

Since the pressure exerts a higher force on the flexible tube than the spring, the flexible tube is expanded radially by the application of pressure and opens toward the second, preferably smaller, control chamber on the residual pressure side. In the process, the flexible tubular piece is lifted off the radial intermediate wall. Once the filling pressure is reached, the pressure source switches off. The control chamber on the filling side is depressurized, the flexible tubular piece returns to the initial position. However, the residual pressure in the control chamber on the residual pressure side cannot open the valve in turn, i.e. lift the flexible tubular piece off the intermediate wall, since the pressurized area of the flexible tube is smaller than the area of the flexible tube of the control chamber on the filling side. The relation between the sizes of the areas of the flexible tube enclosing the control chambers and their absolute values can thus likewise be used according to the invention for adjusting the response behavior of the valve.

As far as the shaping of the control element which is optimal for its function and mounting is concerned, this can preferably have oppositely convergent conical end regions for mounting and can in each case be provided with a cylindrical and/or conical step-like turned portion at its axial ends, which are used for fixing during mounting and for mounting inspection and security.

The ends of the flexible tubular piece can be fixed to the control element and in a similar way also to the housing, in particular via retaining elements such as annular grooves, on annular retaining beads of the flexible tubular piece and via retaining elements of the control element which act in a form-fitting and/or force-fitting manner and are preferably arranged on the conical end regions of the latter, and are clamped between the control element and the housing.

The housing in which the ends of the flexible tube are fixed can advantageously comprise two parts, such as two housing halves, which can be connected to each other in a form-fitting and/or force-fitting manner, in particular in a plug-in manner, but additionally or alternatively also by means of latching, screw fixing and/or flanging. The flexible tubular piece can in this way be mounted in the housing so as to be secured against rotation and free of torsion.

In order that no overpressure is produced in the event of a leak, an unpressurized housing chamber surrounding the flexible tubular piece can be vented from the outside through vent openings, so that fluid which is liberated can escape from the housing.

As a result of the retention of the control element in the flexible tubular piece, carried out under prestress, the flexible tubular piece experiences widening in some regions. In order that the ends of the flexible tubular piece remain unaffected by this widening, the flexible tubular piece can have a minimum length matched to the diameter of the control element.

Further advantageous configuration features of the invention are contained in the subclaims and the following description.

In the following text, the invention is to be explained in more detail by using two preferred exemplary embodiments.

### BRIEF DESCRIPTION OF THE DRAWINGS

FIG. 1 shows a partial illustration of a first embodiment of a residual pressure valve according to the invention in an axial half section,

FIGS. 2 and 3 show axial half sections through the housing parts of a residual pressure valve according to the invention, illustrated in FIG. 1, in a state before its mounting,

FIG. 4 shows a longitudinal section through a control element used both in the first and in the second embodiment of a residual pressure valve according to the invention,

FIG. 5 shows an unsectioned illustration, corresponding to FIG. 4, of the control element of a residual pressure valve according to the invention,

FIG. 6 shows a cross-sectional illustration of the control element of a residual pressure valve according to the invention in the section along the line VI-VI in FIG. 5,

FIG. 7 shows a cross-sectional illustration of a first embodiment of a spring clip of a residual pressure valve according to the invention,

FIG. 8 shows a side view of a second embodiment of a spring clip of a residual pressure valve according to the invention,

FIG. 9 shows an overall view of the first embodiment of a residual pressure valve according to the invention, illustrated in FIG. 1, but on a reduced scale,

FIG. 10 shows a second embodiment of a residual pressure valve according to the invention, the illustration corresponding to FIG. 9,

FIG. 11 is a longitudinal section through a residual pressure valve according to the invention, specifically illustrated in the upper half with the flexible tubular piece inserted and illustrated in the lower half without the flexible tubular piece,

FIG. 12 is a longitudinal section through a flexible tubular piece according to the invention according to FIG. 11, and

FIG. 13 is a longitudinal section through an alternative embodiment of a flexible tubular piece according to the invention.

### DETAILED DESCRIPTION OF THE INVENTION

In the drawing figures, identical and mutually corresponding parts are always provided with the same designations, so that they are generally also described only once.

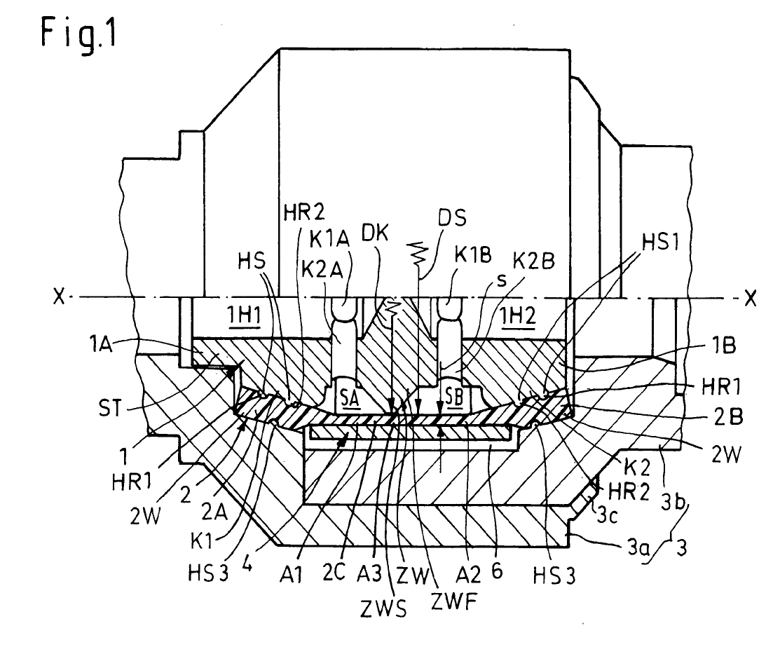

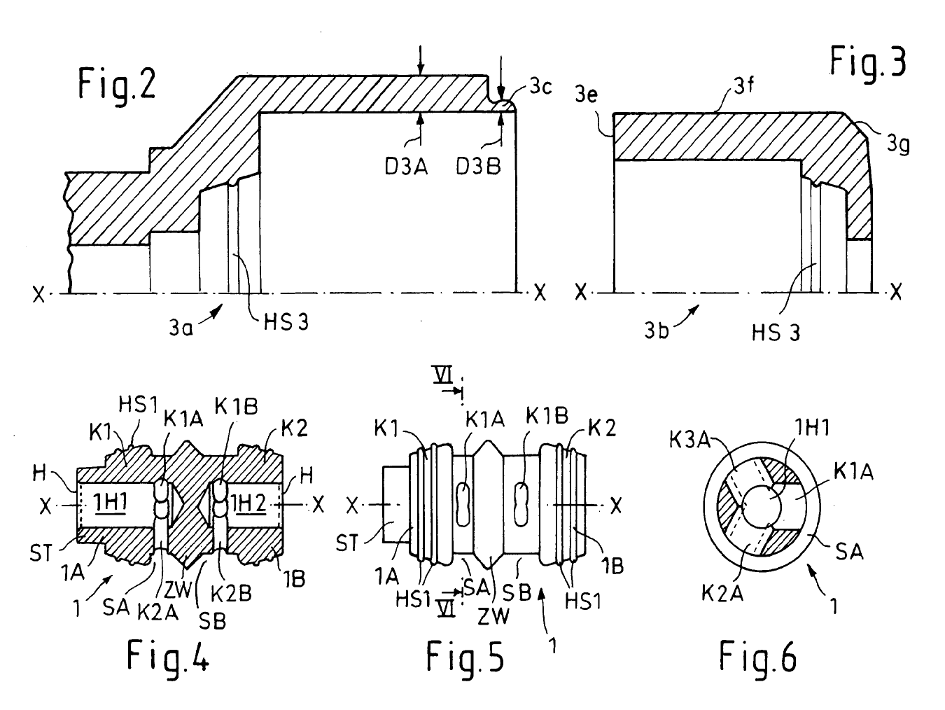

FIG. 1 illustrates a first embodiment of a residual pressure valve according to the invention, which is used as a residual pressure maintaining valve for air suspension systems, which for the purpose of a better illustration is shown in FIGS. 2 to 9 in various views, including its individual parts, comprises a valve body and a valve seat. The valve body is formed by a control element 1 with an axially symmetrical cross section with respect to its longitudinal axis, and the valve seat is formed by a flexible tubular piece 2 consisting of an elastomer, which is fixed in a housing 3. The ends 2A, 2B of the flexible tubular piece 2 are clamped between the control element 1 and the housing 3.

The housing 3 comprises in particular at least two housing parts 3a, 3b, which are illustrated as individual parts in FIGS. 2 and 3 and can be connected to each other with a form and/or force fit. In this case, the mutual connection can preferably be carried out in a manner which is simple to mount by means of plugging and, as shown in the first embodiment, by flanging, in particular via a flanged edge 3c formed on a housing part 3a. The flanged edge 3c, which is formed by a circumferential bead at one end having a central thickness D3B which is reduced as compared with the wall thickness D3A of the housing part 3a, can be gathered particularly clearly from FIG. 2—in the as yet unflanged state.

As FIG. 1 also shows, in addition to being embraced by the flexible tubular piece 2, the control element 1 is also embraced by a spring 4, preferably a spring clip, surrounding the flexible tubular piece 2 circumferentially. The flexible tubular piece 2 and the spring clip 4 surround the control element 1 under elastic prestress, as a result of which it has a circumferential widening 2C in the central region, in which the control element 1 is seated. In this case, a desired response pressure of the valve according to the invention can be set by a predetermined prestress being set by matching an average diameter DS and the wall thickness S of the flexible tubular piece 2 in the unstressed state, taking account of the elasticity of the flexible tube material, to a diameter DK of the control element 1. The flexible tubular piece 2 can have a minimum length, not specifically designated, which is matched to the diameter DK of the control element 1 in such a way that the ends 2A, 2B of the flexible tubular piece 2 remain unaffected by the widening 2C of the flexible tubular piece 2 by the control element 1. Additionally, or virtually also exclusively, the predetermined elastic prestress can be set with the aid of the spring 4 surrounding the flexible tubular piece 2 circumferentially, specifically by means of its geometry and characteristic.

The flexible tubular piece 2 can be provided with a friction reducing layer, for example of PTFE lubricating varnish, for the purpose of improved mounting and for reliable operation. This friction reducing layer can be applied to one side or else to both sides.

As can be gathered from FIG. 1 and also FIGS. 4 to 6, the control element 1 of the residual pressure valve according to the invention has a cylindrical, barrel-like or biconical basic shape, in each case a hollow space 1H1, 1H2 originating from each of its axial ends 1A, 1B being formed. Each of the hollow spaces 1H1, 1H2 is connected to an annular or circumferential control chamber SB, SA, in each case via at least one radially oriented channel. In this case, radial transverse means a course of the transverse bore at an angle of about 45° up to and including 90° with respect to the longitudinal axis X-X. As FIG. 6 shows, in the preferred embodiment illustrated, in each case three channels K1A, K2A, K3A, K1B, K2B, K3B formed as radial transverse bores running at an angle of 80° and offset by 120° from one another in each case are provided. These annular control chambers SA, SB are arranged as circumferential grooves in the outer surface of the control element 1 and are separated from the respective other control chamber SB, SA by a radial intermediate wall ZW resting on the flexible tubular piece 2. The intermediate wall ZW has a wide foot ZWF and converges in the radial direction toward a point ZWS, which is flattened or slightly rounded on the upper side. The peripheral walls of the control chambers SA, SB are in this case each formed by sections A1, A2 of the flexible tubular piece 2. In an embodiment which is simple in terms of fabrication, the hollow spaces 1H1, 1H2 are formed by blind bores originating from the axial ends 1A, 1B of the control elements 1. The control chambers SA, SB have a different size, in particular the control chamber SB being designed to be larger with regard to the section A2 of the flexible tubular piece 2 resting peripherally on the filling side than the control chamber SA with regard to the section A1 of the flexible tubular piece 2 resting peripherally on a residual pressure side, so that the control chamber SB forms a larger effective pressure area on the surrounding flexible tubular piece 2 than the control chamber SA.

When a medium under filling pressure flows into the residual pressure valve according to the invention from the filling side (side of the housing part 3b or the end 1B of the control element), it passes through the hollow space 1H2 arranged on the filling side, through the radially oriented channels K1B, K2B, K3B (cf. FIG. 1, K3B is not illustrated in figure), into the first control chamber SB, which is larger, in particular in comparison with the other chamber SA. The enclosing area of the flexible tube section A2 of the flexible tubular piece 2 is pressurized by the filling pressure. As long as a predetermined response pressure is not reached, the area of the flexible tube enclosing the control chamber SB in the region of the section A2 blocks the flow of the fluid.

In this case, the response pressure is set less by the predetermined prestress of the flexible tubular piece 2 than with the aid of the spring clip 4 surrounding the flexible tubular piece 2 circumferentially. The fluid pressure therefore acts against the prestress produced by the flexible tubular piece 2 and primarily against the comparatively higher prestress from the spring force of the spring clip 4.

When the pressure of the fluid in chamber SB reaches the response pressure, the flexible tubular piece 2 is expanded radially by the pressurization in such a way that a section A3 of the flexible tubular piece 2 which is located between the two sections A1, A2 located on the control chambers SA, SB, which initially rests on the intermediate wall ZW, lifts off the wall ZW. As a result, a flow path to the control chamber SA on the residual pressure side is opened for the fluid. Once the filling pressure is reached, the pressure source switches off. The control chamber SB becomes unpressurized, the flexible tubular piece 2, in particular its section A3, returns into the initial position. In particular as a result of the flattened or rounded shape of the tip ZWS of the intermediate wall ZW, in the quiescent state, the section A3 rests closely and in a tightly sealing manner on the outer contour of the control element 1 without any risk of damage. The residual pressure obtained in the control chamber SA on the residual pressure side, for example at a level of up to 6 bar, is now not able to open the valve in turn, that is to say to lift the flexible tubular piece off the intermediate wall ZW in its section A3, since the pressurized area of the flexible tube in the corresponding section A1 is too small for this purpose.

The control element 1 has oppositely convergent conical end regions K1, K2 for its mounting. In addition, in order to mount the control element 1, in particular as an axial termination of its conical end region K1 at its end 1A on the residual pressure side, a step-like turned portion ST is provided.

The flexible tubular piece 2 can advantageously be mounted in the housing 3 so as to be secure against rotation and free of torsion, the ends 2A, 2B of the flexible tubular piece 2 being fixed to the control element 1 in particular via retaining elements HR1, such as annular grooves, which are formed on annular retaining beads 2W on the flexible tubular piece 2, and via corresponding formfitting and/or force-fitting retaining elements HS1 of the control element 1, which are preferably arranged on its conical end regions K1, K2. Furthermore, in addition to the clamping of the flexible tubular piece 2 already mentioned above, provision can be made for the ends 2A, 2B of the flexible tubular piece 2 to be fixed to the housing 3 in particular via retaining elements HR2, such as annular grooves, which are likewise formed on the annular retaining beads 2W of the flexible tubular piece 2, and corresponding form-fitting and/or force-fitting retaining elements HS3 of the housing 3, such as circumferential protrusions (see in particular FIGS. 2 and 3).

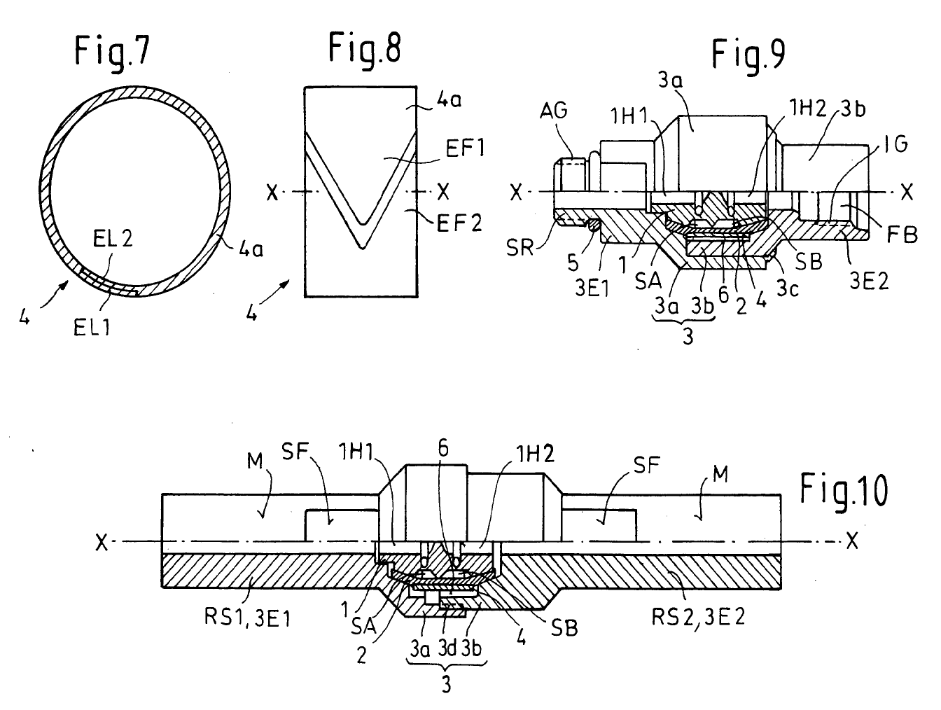

The spring clip 4 can be designed in different forms, as FIGS. 7 and 8 illustrate. Thus, FIG. 7 shows an embodiment in which end regions EL1, EL2 of a spring strip 4a bent in the shape of a ring and preferably fabricated from spring steel overlap, and FIG. 8 shows an embodiment in which the end regions EF1, EF2 of such a spring strip 4a interengage with a form fit, in detail in a V shape in the embodiment shown. Both embodiments ensure an optimal uniform exertion of pressure of the spring clip 4 on the flexible tubular piece 2 enclosed by it.

The housing 3, comprising the housing parts 3a and 3b, can further be designed to the effect that a leakage path is provided as a vent opening in the surfaces 3e, 3f, 3g, see FIG. 3, or their complementary surfaces in the part 3a. The leakage path is preferably formed in the region of the surfaces 3e and 3g by means of flanging and, in the region of the surface 3f, by depressed surfaces, such as key surfaces.

Furthermore, according to the invention, provision can be made for filters H to be arranged at the axial ends of the hollow spaces 1H1 and 1H2, see FIG. 4. As a result of arranging the filters H, the hollow spaces 1H1 and 1H2 and the channels K1A, K2A, K3A, K1B, K2B, K3B and the control chambers SA and SB, the intermediate wall ZW and the flexible tubular piece 2 can be kept free of disruptive dirt particles.

The overall view shown in FIG. 9 of the first embodiment of a residual pressure valve according to the invention, illustrated partially in FIG. 1, shows that axial ends 3E1, 3E2 of the housing 3 are formed differently, in particular one end 3E2 having a shaped bore FB to form a plug receptacle and the other end 3E1 being designed as a plug having a sealing ring 5. An axial end 3E2 of the housing 3, preferably on its filling side, has an internal thread IG, while the other axial end 3E1, preferably on the residual pressure side, has an external thread AG. The end 3E1 on the residual pressure side of the housing 3 is formed as a connector SR.

The second embodiment of the invention, illustrated in FIG. 10, has the same basic structure as the first embodiment. As distinct from this, however, the axial ends 3E1, 3E2 of the housing 3 of the residual pressure valve according to the invention are formed identically, specifically as tubular pieces RS1, RS2, the housing parts 3a, 3b being joined together by a screw connection 3d. In the outer circumferential surface M of the housing 3, in particular in the outer circumferential surfaces M of both housing parts 3a, 3b, spanner surfaces SF for the attachment of a tool are formed in order to make mounting easier.

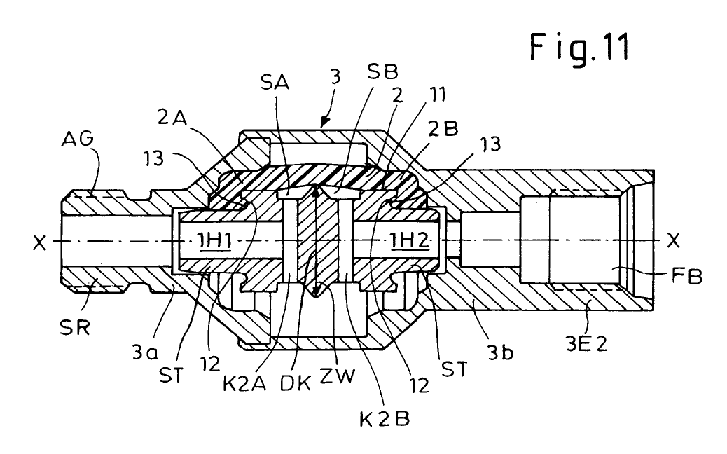

FIG. 11 illustrates a further embodiment of a residual pressure valve according to the invention, identical or functionally identical parts to those in FIGS. 1 to 10 being provided with the same reference identifiers.

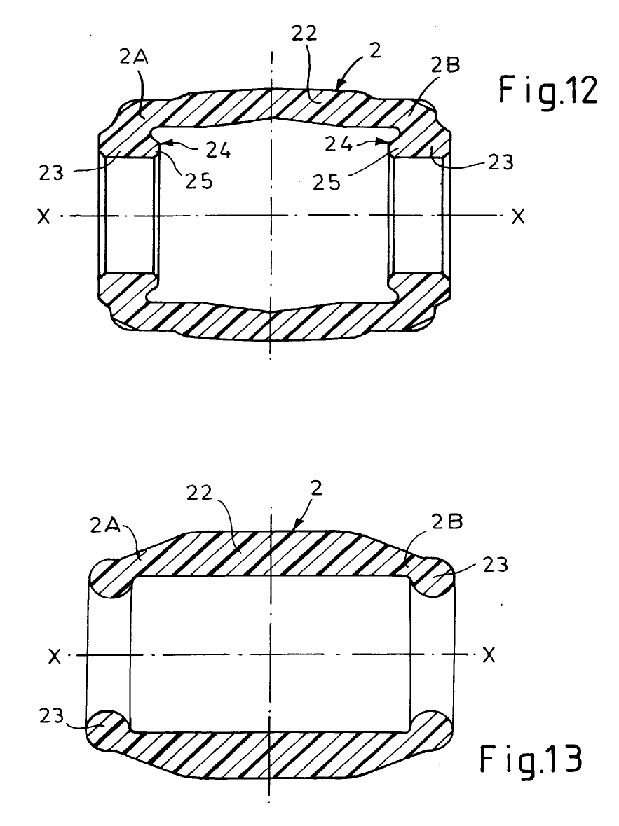

In this case, the flexible tubular piece 2 is formed as a shaped flexible tube, see FIG. 12, having a substantially hollow cylindrical center piece 22, on whose two ends annular sealing beads 23 angled over radially inward are integrally molded. These sealing beads have on their inner side 24 a sealing contour with a sealing section 25 projecting axially inward, which has a partially circular cross section. A sealing contour like an O ring is formed in this way. On the outside of the sealing bead 23, opposite the sealing section 25, the former is illustrated as flattened. However, it can also be curved convexly.

The flexible tubular piece 2 is clamped in a form-fitting and force-fitting manner with its end regions and the sealing beads 23 between the housing parts 3a, 3b of the housing 3 and the control element 1. On both sides of its control chambers SA, SB, the control element 1 has a cylindrical section 11, whose external diameter is smaller than the external diameter DK of the intermediate wall ZW. In its outer end walls 12 running radially, annular grooves 13 which have the shape of a part circle in cross section are formed, which accommodate the sealing sections 25 of the sealing beads 23, so that the sealing function of an O ring results in this region. The end walls 12 are each adjoined by the step-like cylindrical turned portions ST, which have a smaller external diameter than the sections 11, which project into corresponding cylindrical sections of bores in the housing parts 3a, 3b, so that the sealing beads 23 are encapsulated.

Overall, by means of the sealing beads 23 in conjunction with the adaptation of the shapes of the contours of control element 1 and housing 3, the result is an optimized sealing and retaining function of the control valve according to the invention.

A modified embodiment of a flexible tubular piece 2 in relation to that according to FIG. 12 is shown in FIG. 13. This flexible tubular piece 2 has two end sections originating from its hollow cylindrical center part 22, at the ends of which sealing beads 23 of circular cross section are integrally molded, so that the result is a formation like an O ring in this region. By means of an external contour and internal contour of control element 1 and housing parts 3a, 3b which are matched to the end sections and the sealing bead 23, the flexible tubular piece 2 is clamped in with a form and force fit, the sealing beads 23 effecting an O ring seal.

As the possible differences in the embodiments illustrated already show, the valve according to the invention, with its advantageously compact design, which is simple to fabricate and saves material and is also easy to mount, and with its secure and precise function, is not restricted to the exemplary embodiments described but also comprises all the equivalent embodiments in the sense of the invention. For example, it would be possible to use an ellipsoid of rotation instead of the control element 1 illustrated without departing from the scope of the invention. The ends 3E1, 3E2 of the housing 3 can if required be provided with connecting means for a latching means, in a departure from the embodiments illustrated. Retaining arms, at least two, preferably three, for the respective other housing part could be formed on at least one housing part 3a, 3b, preferably on both housing parts 3a, 3b. The housing 3, as illustrated, can also comprise an unpressurized housing chamber 6 surrounding the flexible tubular piece 2 and the spring clip 4, which housing is vented from outside via vent openings (not shown). As a result, in the event of leakage, the formation of a hazardous overpressure in the housing 3 is avoided.

It is therefore intended that the foregoing detailed description be regarded as illustrative rather than limiting, and that it be understood that it is the following claims, including all equivalents, that are intended to define the spirit and scope of this invention.

1. A residual pressure valve comprising a flexible tubular piece which is fixed in a housing, the tubular piece formed of an elastomer and surrounds a control element under elastic prestress, the control element having a generally cylindrical shape and has first and second hollow spaces in each case starting respectively from first and second axial ends the first and second hollow spaces connected via at least one channel to first and second annular control chambers, which are arranged in the outer surface of the control element the control chambers separated by a radial intermediate wall resting on the flexible tubular piece, whereby fluid within the annular control chambers upon reaching a predetermined pressure causing the flexible tubular piece to expand away from the radial intermediate wall allowing fluid communication between the annular control chambers.

2. The residual pressure valve as claimed in claim 1, wherein the control chambers have a different size such that the first control chamber has a larger effective pressure area acting on the flexible tubular piece as compared with the second control chamber the first control chamber on a filling side of the valve.

3. The residual pressure valve as claimed in claim 1, wherein the predetermined pressure is set by matching the diameter and the wall thickness of the flexible tubular piece in the unstressed state, and being affected by the elasticity of the flexible tubular piece, and an average diameter of the control element in the region contact with the intermediate wall.

4. The residual pressure valve as claimed in claim 1, wherein the predetermined pressure is affected with the aid of a spring circumferentially surrounding the flexible tubular piece.

5. The residual pressure valve as claimed in claim 1, wherein the first and second hollow spaces are formed by blind bores originating from the first and second axial ends of the control element.

6. The residual pressure valve as claimed in claim 1, wherein, in order to connect the first and second hollow spaces to the first and second control chambers, the channels are formed as radial transverse bores running at an angle of 90° and offset by 120° from one another in each case are provided.

7. The residual pressure valve as claimed in claim 1, wherein the flexible tubular piece is mounted in the housing so as to be secured against rotation and free of torsion.

8. The residual pressure valve as claimed in claim 1, wherein the flexible tubular piece is formed as a shaped flexible tube having two ends on which annular sealing beads are formed and are retained in a sealing manner under deformation in corresponding chambers formed between the control element and the housing.

9. The residual pressure valve as claimed in claim 8, wherein the sealing and retaining elements are formed wholly or partly in the manner of O rings.

10. The residual pressure valve as claimed in claim 1, wherein the flexible tubular piece is axially symmetrical.

11. The residual pressure valve as claimed in claim 1, wherein the control element has oppositely convergent conical end regions for mounting.

12. The residual pressure valve as claimed in claim 1, wherein the ends of the flexible tubular piece are fixed to the control element via retaining elements, which are formed on annular retaining beads on the flexible tubular piece, and via corresponding form-fitting retaining elements of the control element.

13. The residual pressure valve as claimed in claim 1, wherein the ends of the flexible tubular piece are fixed to the housing via retaining elements, which are likewise formed on the annular retaining beads of the flexible tubular piece, and corresponding form-fitting retaining elements of the housing.

14. The residual pressure valve as claimed in claim 1, wherein the ends of the flexible tubular piece are clamped between the control element and the housing.

15. The residual pressure valve as claimed in claim 1, wherein, in order to mount the control element, in particular as an axial termination of its second end, said control element has a step-like turned portion.

16. The residual pressure valve as claimed in claim 1, wherein the housing comprises at least two housing parts, which can be connected to each other with a mating.

17. The residual pressure valve as claimed in claim 16, wherein the housing parts can be connected to each other by plugging.

18. The residual pressure valve as claimed in claim 16, wherein the housing parts can be connected to each other by flanging, including a flanged edge formed on a housing part.

19. The residual pressure valve as claimed in claim 16, wherein the housing parts can be connected to each other by a screw connection.

20. The residual pressure valve as claimed in claim 16, wherein the housing parts can be connected to each other by means of latching.

21. The residual pressure valve as claimed in claim 16, wherein at least two retaining arms for the respective other housing part are formed on at least one housing part.

22. The residual pressure valve as claimed in claim 1, wherein the housing comprises an unpressurized housing chamber surrounding the flexible tubular piece, which housing is vented from outside via vent openings.

23. The residual pressure valve as claimed in claim 1, wherein the flexible tubular piece has a minimum length which is matched to the diameter of the control element in such a way that the ends of the flexible tubular piece remain unaffected by a widening of the flexible tubular piece by the control element.

24. The residual pressure valve as claimed in claim 1, wherein axial ends of the housing are formed differently, in particular one end having a shaped bore as a plug receptacle and the other end being designed as a plug.

25. The residual pressure valve as claimed in claim 1, wherein an axial end of the housing, preferably on a filling side of the housing, has an internal thread, while the other axial end, preferably on a residual pressure side of the housing, has an external thread.

26. The residual pressure valve as claimed in claim 1, wherein filters are arranged at the axial ends of the hollow spaces in order to intercept dirt particles.

27. The residual pressure valve as claimed in claim 1, wherein vent openings are provided as a leakage path in circumferential surfaces and/or in the surfaces of the housing part that are complementary to the above circumferential surfaces.

28. A residual pressure valve having a valve body and a valve seat, the valve seat being formed by a flexible tubular piece which is fixed in a housing, consists of an elastomer and surrounds the valve body under elastic prestress, and the valve body being formed by an axially symmetrical control element, wherein the control element has a cylindrical, barrel-like or biconical basic shape and has a hollow space in each case starting from each of its axial ends, which is in each case connected via at least one channel to an in particular annular control chamber, which is arranged in the outer surface of the control element and is separated from the respective other control chamber by a radial intermediate wall resting on the flexible tubular piece, a predeterminable prestress being set with the aid of a spring surrounding the flexible tubular piece circumferentially.

29. (canceled)

30. The residual pressure valve as claimed in claim 1, wherein the flexible tubular piece is axially asymmetrical.
